(19) United States
(12) Patent Application Publication
(10) Pub. No.: US 2024/0249708 A1
(43) Pub. Date: Jul. 25, 2024

(54) NON-TRANSITORY COMPUTER-READABLE MEDIUM, TIMBRE SETTING DEVICE AND TIMBRE SETTING METHOD

(71) Applicant: Roland Corporation, Shizuoka (JP)

(72) Inventors: Makoto Mitsumori, Hamamatsu (JP); Atsushi Hoshika, Hamamatsu (JP); Ayaka USUI, Hamamatsu (JP)

(73) Assignee: Roland Corporation, Shizuoka (JP)

(21) Appl. No.: 18/505,042

(22) Filed: Nov. 8, 2023

(30) Foreign Application Priority Data
Jan. 20, 2023 (JP) 2023-007369

(51) Int. Cl. G10H 1/02

(52) U.S. Cl. CPC G10H 1/02; G10H 2220/116

(57) ABSTRACT

A timbre setting program causes a computer equipped with a displayer and an input unit that accepts a user operation to execute timbre setting processing for setting a timbre. The timbre setting program causes the computer to execute processing including: displaying modules constituting the timbre on the displayer; acquiring, in the modules displayed, a module selected via the input unit as a setting target module; and displaying a setting area where the module acquired is set on the displayer.

### CROSS-REFERENCE TO RELATED APPLICATIONS

This application claims the priority benefit of Japan Application No. 2023-007369, filed on Jan. 20, 2023. The entirety of the above-mentioned patent application is hereby incorporated by reference herein and made a part of this specification.

### BACKGROUND

### Technical Field

The disclosure relates to a timbre setting program, a timbre setting device, and a timbre setting method.

### Related Art

Japanese Patent Laid-Open No. 2013-257517 discloses a program that displays a virtual keyboard A simulating a keyboard and a virtual knob manipulator B simulating a knob. In this program, when a key of the virtual keyboard A is touched, a corresponding musical tone is output; when the virtual knob manipulator B is operated, a musical tone control parameter (module) constituting a musical tone is changed. It is configured that the musical tone control parameter to be changed by operation can be pre-assigned to each virtual knob manipulator B.

While there are many settable musical tone control parameters for musical tones, there is a limit to the number of virtual knob manipulators B to be displayed. Accordingly, it is not possible to assign all the settable musical tone control parameters to the virtual knob manipulators B at once. Thus, a user is unable to understand the settable musical tone control parameters, and is unable to perform satisfactory setting regarding the musical tones. In the case of performing setting across a plurality of musical tone control parameters, every time it is necessary to assign a musical tone control parameter to be set to the virtual knob manipulator B. As a result, there is a problem that user operability in setting the musical tone control parameters deteriorates.

### SUMMARY

A non-transitory computer-readable medium of the disclosure records a timbre setting program being a program that causes a computer equipped with a displayer and an input unit that accepts a user operation to execute timbre setting processing for setting a timbre. The timbre setting program causes the computer to execute processing including: displaying modules constituting the timbre on the displayer; acquiring, in the modules displayed, a module selected via the input unit as a setting target module; and displaying a setting area where the module acquired is set on the displayer.

A timbre setting device of the disclosure includes: an input part, accepting a user operation; a module display part, displaying modules constituting a timbre; an acquisition part, acquiring, in the modules displayed by the module display part, a module selected via the input part as a setting target module; and a setting area display part, displaying a setting area where the module acquired by the acquisition part is set.

A timbre setting method of the disclosure is a method executed by a timbre setting device equipped with an input part that accepts a user operation. The timbre setting method includes the following. Modules constituting a timbre are displayed. In the modules displayed, a module selected via the input part is acquired as a setting target module. A setting area is displayed where the module acquired is set.

### BRIEF DESCRIPTION OF THE DRAWINGS

FIG. 1A is an external view of a personal computer (PC). FIG. 1B illustrates a timbre setting screen.

FIG. 2A illustrates a case where first low frequency, second low frequency, filter, and filter envelope of a first partial area are selected by a selection display. FIG. 2B illustrates a case where filter, filter envelope, amplifier envelope, and equalizer of the first partial area are selected by the selection display.

FIG. 3A illustrates the timbre setting screen in a case where pitch envelope of each partial is selected by the selection display. FIG. 3B illustrates a candidate display. FIG. 3C illustrates a case where amplifier envelope of each partial is selected by the candidate display.

FIG. 4 is a functional block diagram of the PC.

FIG. 5 is a block diagram illustrating an electrical configuration of the PC.

FIG. 6 is a flowchart of main processing.

FIG. 7A is a flowchart of timbre change processing. FIG. 7B is a flowchart of display update processing.

FIG. 8A is a flowchart of lateral processing. FIG. 8B is a flowchart of vertical processing.

FIG. 9A illustrates a module area in a case where a timbre is composed of four partials in a modification. FIG. 9B illustrates a module area in a case where a timbre is composed of one partial in another modification. FIG. 9C illustrates a candidate display in the module area of FIG. 9B.

### DESCRIPTION OF THE EMBODIMENTS

The disclosure provides a timbre setting program, a timbre setting device, and a timbre setting method in which user operability in setting a module constituting a timbre can be enhanced.

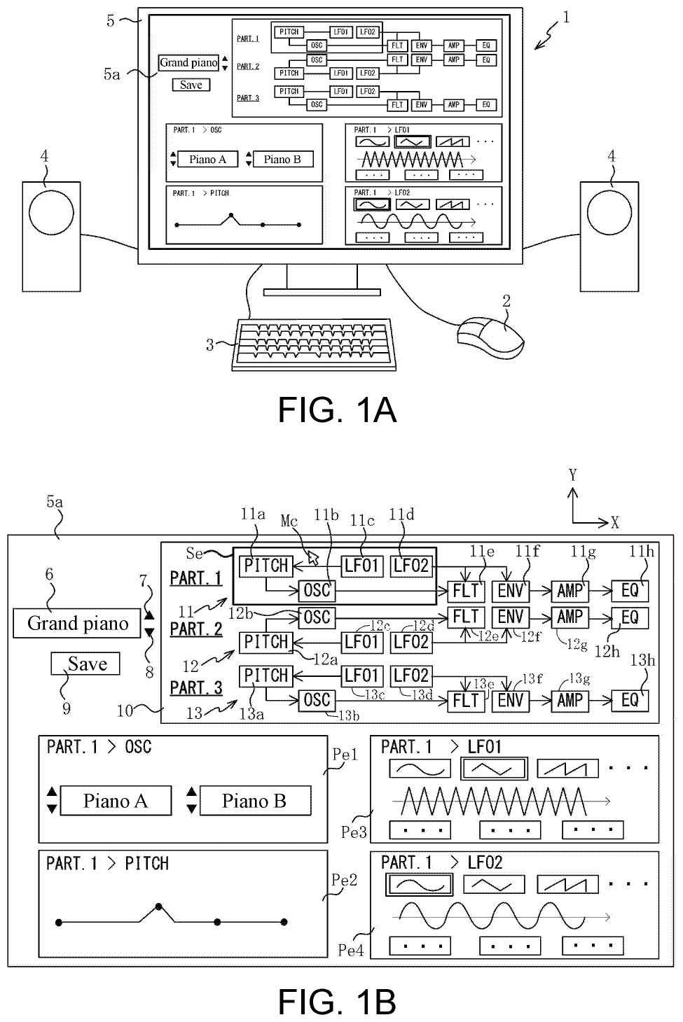

Hereinafter, embodiments will be described with reference to the accompanying drawings. An outline of a personal computer (PC) 1 of the present embodiment is described with reference to FIG. 1A. FIG. 1A is an external view of the PC 1. The PC 1 is an information processing device (computer) for setting a timbre and is used in outputting a musical tone in response to a performance operation by a user H or the like. The PC 1 is provided with a mouse 2 and a keyboard 3 that input an instruction from the user H, a speaker 4 that outputs sound, and a display device 5 that displays various setting screens or the like.

The display device 5 displays a timbre setting screen 5a being a screen for setting a timbre. On the timbre setting screen 5a, in response to the instruction from the user H from the mouse 2 and the keyboard 3, a module which is an element constituting a timbre, such as an oscillator or a frequency filter, is set. By setting each module, the timbre is set in detail. The timbre setting screen 5a is described with reference to FIG. 1B to FIG. 3A.

FIG. 1B illustrates the timbre setting screen 5a. On the timbre setting screen 5a in FIG. 1B, a lateral coordinate is an X coordinate, and a vertical coordinate is a Y coordinate. The same applies to the figures below.

The timbre setting screen 5a is provided with a timbre name display 6, an up button 7, a down button 8, a save button 9, a module area 10, and setting areas Pe1 to Pe4. The timbre name display 6 is a display area where a name of a target timbre (hereinafter referred to as “setting target timbre”) to be set on the timbre setting screen 5a, such as “grand piano” or “electric guitar”, is displayed. The up button 7 and the down button 8 are manipulators that switch the setting target timbre. In the case where the up button 7 or the down button 8 is selected via the mouse 2, the setting target timbre is switched, and the name of the timbre after the switching is reflected in the timbre name display 6.

The save button 9 is a manipulator that causes a setting state of a timbre set on the timbre setting screen 5a to be reflected in setting of the timbre. On the timbre setting screen 5a, it is configured that the setting of the timbre can be changed in the setting areas Pe1 to Pe4 to be described later. In the case where the save button 9 is selected via the mouse 2, the setting state set in the setting areas Pe1 to Pe4 at that time is reflected as the setting of the timbre.

The module area 10 is a region where modules that can be set for the setting target timbre are displayed. In the present embodiment, a timbre is composed of a combination of a plurality of modules. More specifically, a module obtained by combining a plurality of modules is one “partial”, and a timbre is formed by combining three partials.

By setting each of the modules included in the three partials (that is, a first partial, a second partial, and a third partial), a volume change or a reverberation length or the like of the timbre can be set in detail. Specifically, in the present embodiment, the modules provided in a partial include: pitch envelope, oscillator, first low frequency, second low frequency, filter, filter envelope, amplifier envelope, and equalizer.

The pitch envelope is a module that sets an envelope (pitch envelope) acting on the oscillator. The envelope from the pitch envelope is input to the oscillator, and applies a temporal change to a pitch of a basic waveform output from the oscillator. The oscillator is a module that sets the basic waveform. The basic waveform output from the oscillator is input to the filter.

The first low frequency is a module that sets a low frequency acting on the pitch envelope. The low frequency from the first low frequency is input to the pitch envelope. The second low frequency is a module that sets a low frequency acting on the filter and the filter envelope. The low frequency from the second low frequency is input to the filter and the filter envelope.

The filter is a module that sets a frequency filter (such as a high-pass filter or a band-pass filter) applied to the basic waveform from the oscillator. The filter envelope is a module that sets an envelope of the frequency filter set by the filter.

The amplifier envelope is a module that sets a temporal change in volume of a waveform output from the filter and the filter envelope. A waveform output from the amplifier envelope is output to the equalizer. The equalizer is a module that sets a frequency characteristic of the waveform output from the amplifier envelope.

All the timbres stored in the PC 1 of the present embodiment are composed of the same combination of partials and modules. For example, a combination of partials and modules in the case of grand piano is the same as a combination of partials and modules in the case of electric guitar.

In the module area 10, displayed are a first partial area 11 (“PART. 1” in the figure) corresponding to the first partial described above, a second partial area 12 (“PART. 2” in the figure) corresponding to the second partial, and a third partial area 13 (“PART. 3” in the figure) corresponding to the third partial. As illustrated in FIG. 1B, the partial areas 11 to 13 are displayed side by side in an up-down direction. A gap is provided between each of the partial areas 11 to 13 in the up-down direction, and the gap is outside of any of the partial areas 11 to 13.

In the first partial area 11, displayed are pitch envelope 11a, oscillator 11b, first low frequency 11c, second low frequency 11d, filter 11e, filter envelope 11f, amplifier envelope 11g, and equalizer 11h, respectively corresponding to the pitch envelope, the oscillator, the first low frequency, the second low frequency, the filter, the filter envelope, the amplifier envelope, and the equalizer of the first partial.

The pitch envelope 11a is arranged at a left end of the first partial area 11. The oscillator 11b is arranged below and on the right side of the pitch envelope 11a. The first low frequency 11c is arranged on the right side of the pitch envelope 11a and on the right side of the oscillator 11b in a left-right direction. That is, the first low frequency 11c is arranged at a position not overlapping the oscillator 11b located below the first low frequency 11c in the left-right direction. The second low frequency 11d is arranged on the right side of the first low frequency 11c.

The filter 11e is arranged to the right of the oscillator 11b and on the right side of the second low frequency 11d in the left-right direction. That is, the filter 11e is arranged at a position not overlapping the second low frequency 11d in the left-right direction. The filter envelope 11f is arranged on the right side of the filter 11e.

The amplifier envelope 11g is arranged on the right side of the filter envelope 11f. The equalizer 11h is arranged to the right of the amplifier envelope 11g.

As described above, each module is arranged in the first partial area 11 according to an input-output relationship between the modules. That is, in the first partial area 11, highly correlated modules are arranged in the vicinity of each other. Accordingly, the user H is able to understand at a glance a module that can be set in a partial corresponding to the first partial area 11 and a correlation between the modules. In the first partial area 11, the modules are arranged so as not to overlap in the left-right direction. This allows the user H to clearly distinguish between one module and the other modules in the first partial area 11.

In the second partial area 12 and the third partial area 13, modules equivalent to those of the first partial area 11 described above are arranged. More specifically, pitch envelope 12a to equalizer 12h are displayed in the second partial area 12 and are arranged in the same manner as the pitch envelope 11a to the equalizer 11h of the first partial area 11 in the left-right direction.

On the other hand, the arrangement of modules in the up-down direction in the second partial area 12 is opposite to that in the first partial area 11. Specifically, oscillator 12b, filter 12e, filter envelope 12f, amplifier envelope 12g and equalizer 12h are arranged in an upper section of the second partial area 12; pitch envelope 12a, first low frequency 12c, and second low frequency 12d are arranged in a lower section of the second partial area 12.

Accordingly, a module (for example, the oscillator 11b) arranged in a lower section of the first partial area 11 and its equivalent module (for example, the oscillator 12b) arranged in the lower section of the second partial area 12 are arranged adjacent to each other in the up-down direction. This allows the user H to recognize that the modules adjacent to each other in the up-down direction while of different partials are modules that are highly correlated and have equivalent functions.

Furthermore, pitch envelope 13a to equalizer 13h in the third partial area 13b are respectively arranged in the same manner as the pitch envelope 11a to the equalizer 11h of the first partial area 11. Thus, a module (for example, the pitch envelope 12a) arranged in the lower section of the second partial area 12 and its equivalent module (for example, the pitch envelope 13a) arranged in an upper section of the third partial area 13 are arranged adjacent to each other in the up-down direction. This also allows the user H to recognize that the modules adjacent to each other in the up-down direction while of different partials are modules that are highly correlated and have equivalent functions.

Among the modules displayed in this way in the module area 10, a selection display Se indicating a setting target module is displayed on a module selected by the user H via the mouse 2. The selection display Se is composed of a region surrounded by a rectangular line (indicated by a thick line in the figure), and a module arranged within the region is selected as the setting target module. The region of the selection display Se is formed according to a position of a mouse cursor Mc when the mouse 2 is clicked. The mouse cursor Mc is an arrow-shaped display part that moves on the timbre setting screen 5a in response to a movement operation of the mouse 2 performed by the user H.

As illustrated in FIG. 1B, in the case of selecting (surrounding) the pitch envelope 11a, the oscillator 11b, the first low frequency 11c, and the second low frequency 11d as the setting target module by the selection display Se, the user H specifies a position on the left side of a right end of the oscillator 11b within the first partial area 11 by the mouse cursor Mc, and clicks the mouse 2. FIG. 1B indicates a case where an intermediate position between the pitch envelope 11a and the first low frequency 11c is specified by the mouse cursor Mc and clicked with the mouse 2.

In FIG. 1B, since the pitch envelope 11a, the oscillator 11b, the first low frequency 11c, and the second low frequency 11d of the first partial area 11 are selected by the selection display Se, setting parts (hereinafter referred to as “setting part of the first low frequency 11c” and the like) respectively for setting the pitch envelope 11a, the oscillator 11b, the first low frequency 11c, and the second low frequency 11d are displayed in the setting areas Pe1 to Pe4 arranged below the module area 10.

The setting areas Pe1 to Pe4 are each a region where a setting part of a module included within the region of the selection display Se is displayed. The setting area Pe1 is arranged on the left side below the module area 10. The setting area Pe2 is arranged below the setting area Pe1. The setting area Pe3 is arranged to the right of the setting area Pe1. The setting area Pe4 is arranged below the setting area Pe3.

As described above, since highly correlated modules are arranged in the vicinity of each other in the module area 10, the highly correlated modules can be included in the selection display Se. Accordingly, since the setting parts of the highly correlated modules are displayed in the setting areas Pe1 to Pe4, the user H is able to perform detailed setting of the modules while comparing the settings of the highly correlated modules.

The arrangement (assignment) of the setting parts of the modules displayed in the setting areas Pe1 to Pe4 is set according to importance of the module included in the selection display Se and degree of correlation between the modules.

For example, in FIG. 1B, the pitch envelope 11a, the oscillator 11b, the first low frequency 11c, and the second low frequency 11d are selected by the selection display Se. Among them, the oscillator 11b that sets the basic waveform of the timbre serves as a basis of the timbre and therefore has many chances to be changed in setting, and is a module of highest importance. Accordingly, the setting part of the oscillator 11b is arranged in the setting area Pe1 that is most noticeable to the user H among the setting areas Pe1 to Pe4, thereby allowing the user H to easily set the basic waveform corresponding to the oscillator 11b.

In FIG. 1B, the first low frequency 11c and the second low frequency 11d are selected by the selection display Se. Since the first low frequency 11c and the second low frequency 11d are both modules that set a low frequency, they are highly correlated modules. Accordingly, by displaying the setting part of the first low frequency 11c in the setting area Pe3 and displaying the setting part of the second low frequency 11d in the setting area Pe4, the modules that set a low frequency can be arranged up and down. Accordingly, the low frequency of each of the first low frequency 11c and the second low frequency 11d can be set while a comparison is made vertically between the settings.

In this way, by setting the arrangement of the setting parts of the modules displayed in the setting areas Pe1 to Pe4 according to the importance of the module selected by the selection display Se and the degree of correlation between the modules, the arrangement of the setting parts of the modules displayed in the setting areas Pe1 to Pe4 can be made corresponding to a tendency of the user H in setting a module. Accordingly, operability of the user H regarding setting a module in the setting areas Pe1 to Pe3 can be enhanced.

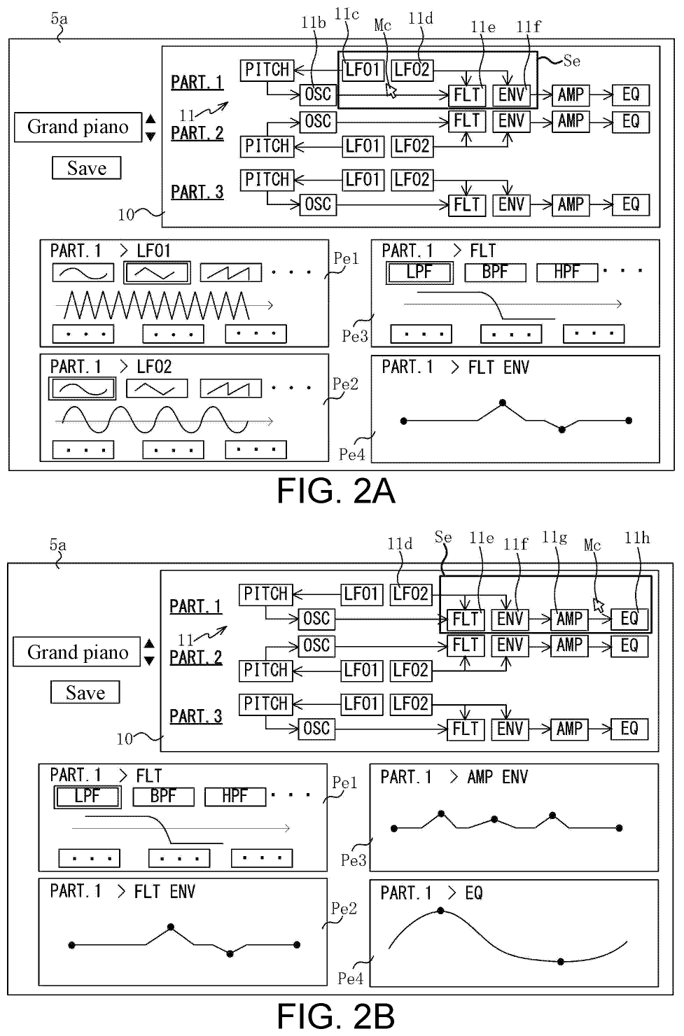

Next, other arrangements of the selection display Se in the first partial area 11 are described with reference to FIG. 2A and FIG. 2B. FIG. 2A illustrates the case where the first low frequency 11c, the second low frequency 11d, the filter 11e, and the filter envelope 11f of the first partial area 11 are selected by the selection display Se. FIG. 2B illustrates the case where the filter 11e, the filter envelope 11f, the amplifier envelope 11g, and the equalizer 11h of the first partial area 11 are selected by the selection display Se.

As illustrated in FIG. 2A, in the case where the first low frequency 11c, the second low frequency 11d, the filter 11e, and the filter envelope 11f of the first partial area 11 are selected by the selection display Se, the setting part of the first low frequency 11c, the setting part of the second low frequency 11d, the setting part of the filter 11e, and the setting part of the filter envelope 11f are respectively displayed in the setting areas Pe1 to Pe4.

The setting part of the filter 11e and the setting part of the filter envelope 11f are displayed vertically in the setting area Pe3 and the setting area Pe4 respectively. Accordingly, each of the filter 11e and the filter envelope 11f that are highly correlated regarding the frequency filter can be set in detail while a comparison is made vertically between the settings.

In this way, in the case of selecting the first low frequency 11c, the second low frequency 11d, the filter 11e, and the filter envelope 11f by the selection display Se, the user H specifies a position on the right side of the right end of the oscillator 11b and on the left side of a right end of the second low frequency 11d within the first partial area 11 by the mouse cursor Mc, and clicks the mouse 2.

As illustrated in FIG. 2B, in the case where the filter 11e, the filter envelope 11f, the amplifier envelope 11g, and the equalizer 11h of the first partial area 11 are selected by the selection display Se, the setting part of the filter 11e, the setting part of the filter envelope 11f, the setting part of the amplifier envelope 11g, and the setting part of the equalizer 11h are respectively displayed in the setting areas Pe1 to Pe4. In this way, in the case of selecting the filter 11e, the filter envelope 11f, the amplifier envelope 11g, and the equalizer 11h by the selection display Se, the user H specifies a position on the right side of the right end of the second low frequency 11d within the first partial area 11 by the mouse cursor Mc, and clicks the mouse 2.

In FIG. 1B, FIG. 2A and FIG. 2B, a case has been described where a module within the first partial area 11 is selected by the selection display Se. The same applies to cases where a module within the second partial area 12 and the third partial area 13 is selected by the selection display Se, and a detailed description is thus omitted.

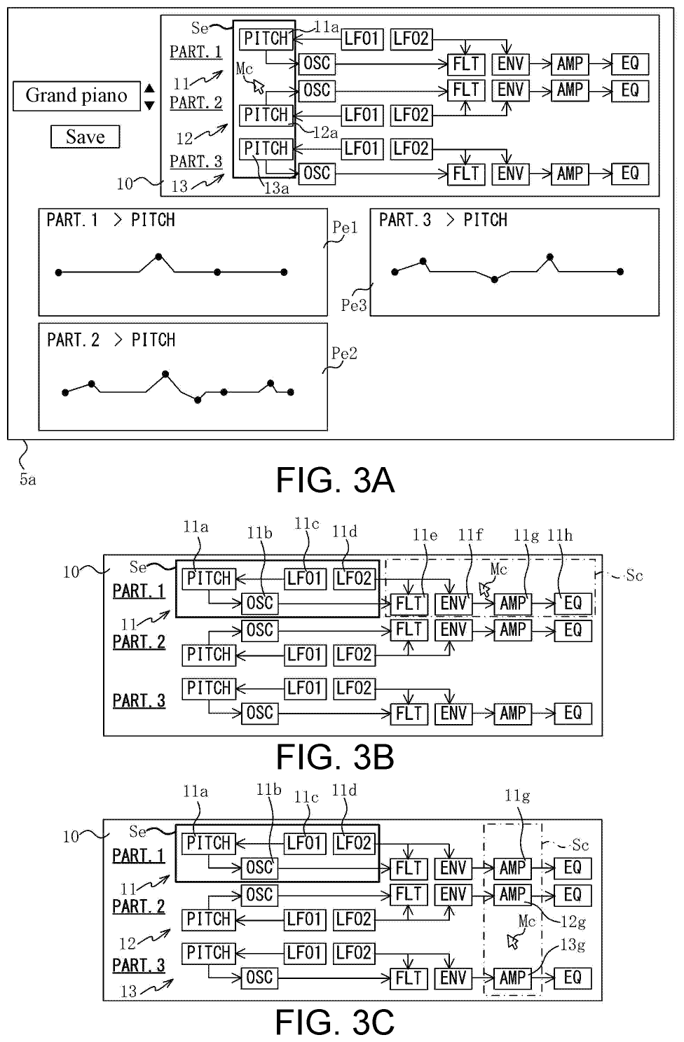

Next, selection of modules across partials is described with reference to FIG. 3A. FIG. 3A illustrates the timbre setting screen in the case where the pitch envelopes 11a, 12a, and 13a of each partial are selected by the selection display Se.

In the present embodiment, equivalent modules in each of the partial areas 11 to 13 are configured to be selectable by the selection display Se. As illustrated in FIG. 3A, the pitch envelope 11a of the first partial area 11, the pitch envelope 12a of the second partial area 12, and the pitch envelope 13a of the third partial area 13 are selected by the selection display Se.

In such a case of selecting the pitch envelopes 11a, 12a, and 13a by the selection display Se, the user H specifies a position outside of the first partial area 11, the second partial area 12 and the third partial area 13 and within a range of the pitch envelopes 11a, 12a, and 13a in the left-right direction, and clicks the position with the mouse 2. Specifically, in FIG. 3A, the user H specifies a position in a gap between the first partial area 11 and the second partial area 12 and within the range of the pitch envelopes 11a, 12a, and 13a in the left-right direction, and clicks the position with the mouse 2. Accordingly, the setting parts of each of the pitch envelopes 11a, 12a, and 13a are displayed together in the setting areas Pe1 to Pe3.

In FIG. 3A, a case has been described where the pitch envelopes 11a, 12a, and 13a are selected by the selection display Se across partials. The same applies to cases where other modules such as the oscillators 11b, 12b, 13b are selected by the selection display Se across partials, and a detailed description is thus omitted.

By selecting equivalent modules across partials together by the selection display Se in this way, the user H is able to compare the settings of the equivalent modules in each partial displayed as the setting parts in the setting areas Pe1 to Pe3. Accordingly, the equivalent modules in each highly correlated partial can be efficiently set. As described above, in the module area 10, since the equivalent modules of each partial are arranged side by side in the up-down direction, the user H is able to easily select the equivalent modules across partials using the selection display Se.

Furthermore, in the partial areas 11 to 13, since the modules arranged in the upper section and the modules arranged in the lower section are arranged so as not to overlap in the left-right direction, when equivalent modules across partials are selected using the selection display Se, a different module near these modules is prevented from being included in the selection display Se. This allows the user H to smoothly select the equivalent modules across partials using the selection display Se.

As described above, the modules constituting the timbre are displayed in the module area 10. Among the modules displayed in the module area 10, a module selected by the selection display Se via the mouse 2 is displayed in the setting areas Pe1 to Pe4 as a module to be set. The module area 10 allows the user H to understand at a glance the modules constituting the timbre.

Furthermore, simply by selecting a desired module among the modules in the module area 10 by the selection display Se via the mouse 2, the user H is able to specify the module to be set in the setting areas Pe1 to Pe4. As a result, since the user H is able to easily understand the modules constituting the timbre and easily specify the module to be set, user operability in setting the module can be enhanced.

The module selected by the selection display Se is not limited to those illustrated in FIG. 1B to FIG. 3A. For example, the module selected by the selection display Se may be arbitrarily set by considering the correlation between the arranged modules. Furthermore, a range (for example, a position on the left side of the right end of the oscillator 11b within the first partial area 11 in the case of the selection display Se in FIG. 1B) of the position of the mouse cursor Mc specified when the selection display Se is formed is not limited to the above, and the range of the position may be arbitrarily set.

In this way, the module displayed in the setting areas Pe1 to Pe4 is selected by the selection display Se. However, there may be cases where the user H may desire to confirm in advance a module selectable by the selection display Se, such as a case where the module displayed in the setting areas Pe1 to Pe4 is to be changed. Accordingly, in the present embodiment, it is configured that a candidate display Sc indicating a candidate for the module selectable by the selection display Se can be displayed. The candidate display Sc is described with reference to FIG. 3B and FIG. 3C.

FIG. 3B illustrates the candidate display Sc. FIG. 3C illustrates a case where the amplifier envelopes 11g, 12g, and 13g of each partial are selected by the candidate display Sc. As illustrated in FIG. 3B, the candidate display Sc is displayed separately from the selection display Se.

The candidate display Sc is a display indicating, among the modules displayed in the module area 10, a candidate for the module selectable by the selection display Se in the vicinity of the position of the mouse cursor Mc, that is, a candidate for the setting target module to be displayed in the setting areas Pe1 to Pe4. The candidate display Sc is composed of a region surrounded by a rectangular line (indicated by dash-dotted lines in the figure). In the vicinity of the position specified by the mouse cursor Mc, a candidate for the module selectable by the selection display Se is selected by the candidate display Sc.

Specifically, in the case where the mouse cursor Mc is located on the left side of the right end of the oscillator 11b within the first partial area 11, the pitch envelope 11a, the oscillator 11b, the first low frequency 11c, and the second low frequency 11d are selected by the candidate display Sc. In the case where the mouse cursor Mc is located on the right side of the right end of the oscillator 11b within the first partial area 11 and on the left side of the right end of the second low frequency 11d, the first low frequency 11c, the second low frequency 11d, the filter 11e, and the filter envelope 11f are selected by the candidate display Sc.

In the case where the mouse cursor Mc is located on the right side of the right end of the second low frequency 11d within the first partial area 11, the filter 11e, the filter envelope 11f, the amplifier envelope 11g, and the equalizer 11h are selected by the candidate display Sc.

In such a state in which a module is selected in the candidate display Sc, when the mouse 2 is clicked, the candidate display Sc is removed, and the module that has been selected by the candidate display Sc is instead selected in the selection display Se. Furthermore, a setting part of the module selected by the selection display Se is displayed in the setting areas Pe1 to Pe4.

In FIG. 3B, a case has been described where a module within the first partial area 11 is selected by the candidate display Sc. The same applies to cases where a module within the second partial area 12 and the third partial area 13 is selected by the candidate display Sc, and a detailed description is thus omitted.

Like the selection display Se described above in FIG. 3A, the candidate display Sc is configured to be able to select modules across partials. As illustrated in FIG. 3C, the mouse cursor Mc is arranged at a position outside of the first partial area 11, the second partial area 12 and the third partial area 13 and within a range of the amplifier envelopes 11g, 12g, and 13g in the left-right direction. Specifically, in FIG. 3C, the mouse cursor Mc is arranged at a position in a gap between the second partial area 12 and the third partial area 13 and within the range of the amplifier envelopes 11g, 12g, and 13g in the left-right direction. Accordingly, the amplifier envelopes 11g, 12g, and 13g are selected by the candidate display Sc.

In FIG. 3C, a case has been described where the amplifier envelopes 11g, 12g, and 13g are selected by the candidate display Sc across partials. The same applies to cases where other modules such as the oscillators 11b, 12b, 13b are selected by the candidate display Sc across partials, and a detailed description is thus omitted.

By visually recognizing the candidate display Sc displayed in the vicinity of the position of the mouse cursor Mc while moving the mouse cursor Mc via the mouse 2, the user H is able to confirm in advance which module is to be selected by the selection display Se in the case where the mouse 2 is clicked. Accordingly, the user H is able to intuitively and smoothly select the module to be set in the setting areas Pe1 to Pe4.

The module selected by the candidate display Sc is not limited to those illustrated above. For example, the module selected by the candidate display Sc may be arbitrarily set by considering the correlation between the arranged modules. Furthermore, a range (for example, a position on the right side of the right end of the second low frequency 11d in the case of the candidate display Sc in FIG. 3B) of the position of the mouse cursor Mc specified when the candidate display Sc is formed is not limited to the above, and the range of the position may be arbitrarily set.

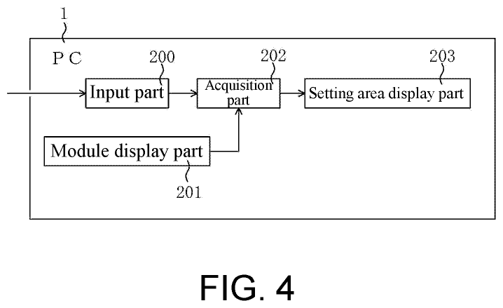

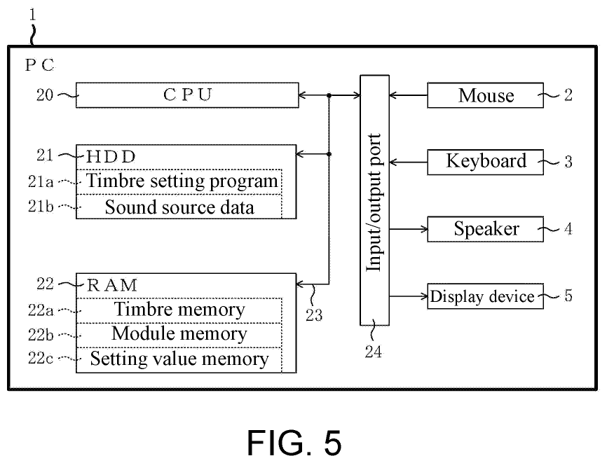

Next, a function of the PC 1 is described with reference to FIG. 4. FIG. 4 is a functional block diagram of the PC 1. As illustrated in FIG. 4, the PC 1 includes an input part 200, a module display part 201, an acquisition part 202, and a setting area display part 203. The input part 200 is a means of accepting an operation by the user H, and is realized by the mouse 2. The module display part 201 is a means of displaying modules constituting a timbre, and is realized by a CPU 20 to be described later in FIG. 5.

The acquisition part 202 is a means of acquiring, from among the modules displayed by the module display part 201, a module selected via the input part 200 as the setting target module, and is realized by the CPU 20. The setting area display part 203 is a means of displaying the setting areas Pe1 to Pe4 where a setting part sets the module acquired by the acquisition part 202, and is realized by the CPU 20.

In the PC 1, the modules constituting the timbre are displayed. Among the displayed modules, with the module selected via the input part 200 as the module to be set, a corresponding setting part is displayed in the setting areas Pe1 to Pe4. This allows the user H to understand at a glance the modules constituting the timbre.

Furthermore, simply by selecting a desired module among the displayed modules by the input part 200, the user H is able to specify the module to be set in the setting areas Pe1 to Pe4. As a result, since the user H is able to easily understand the modules constituting the timbre and easily specify the module to be set, the operability of the user H in setting the module can be enhanced.

Next, an electrical configuration of the PC 1 is described with reference to FIG. 5. FIG. 5 is a block diagram illustrating an electrical configuration of the PC 1. The PC 1 includes the CPU 20, a hard disk drive (HDD) 21, and a RAM 22 each of which is connected to an input/output (I/O) port 24 via a bus line 23. The mouse 2, the keyboard 3, the speaker 4, and the display device 5 are further connected to the I/O port 24.

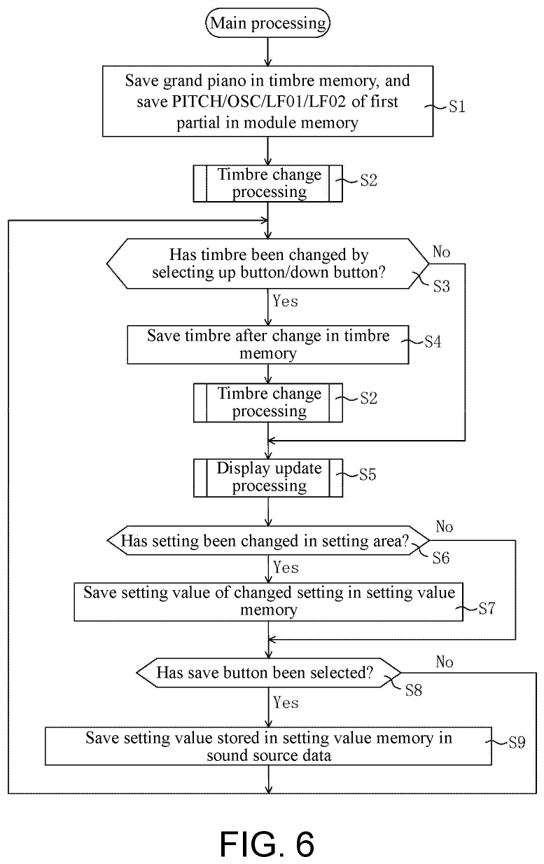

The CPU 20 is an arithmetic unit that controls each part connected by the bus line 23. The HDD 21 is a rewritable non-volatile storage device storing programs executed by the CPU 20 or fixed value data or the like, in which a timbre setting program 21a and sound source data 21b are stored. When the timbre setting program 21a is executed in the CPU 20, main processing of FIG. 6 is executed.

In the sound source data 21b, timbre-related information is stored. Specifically, the sound source data 21b stores, for each timbre, a configuration of a partial and a module constituting the timbre, a setting value of each module, and a display part displayed in the module area 10 or a setting part displayed in the setting areas Pe1 to Pe4. The display part of the module area 10 or the setting part of the setting areas Pe1 to Pe4 is not necessarily stored in the sound source data 21b, and may be stored in a different region from the sound source data 21b in the HDD 21.

The RAM 22 is a memory for rewritably storing various work data or flags or the like when the CPU 20 executes the timbre setting program 21a. The RAM 22 is provided with a timbre memory 22a storing the setting target timbre, a module memory 22b storing a module selected by the selection display Se, and a setting value memory 22c storing a setting value of each module of the setting target timbre.

Next, the main processing executed by the CPU 20 of the PC 1 is described with reference to FIG. 6 to FIG. 8B. FIG. 6 is a flowchart of the main processing. The main processing is processing executed in the case where the PC 1 is instructed to execute the timbre setting program 21a.

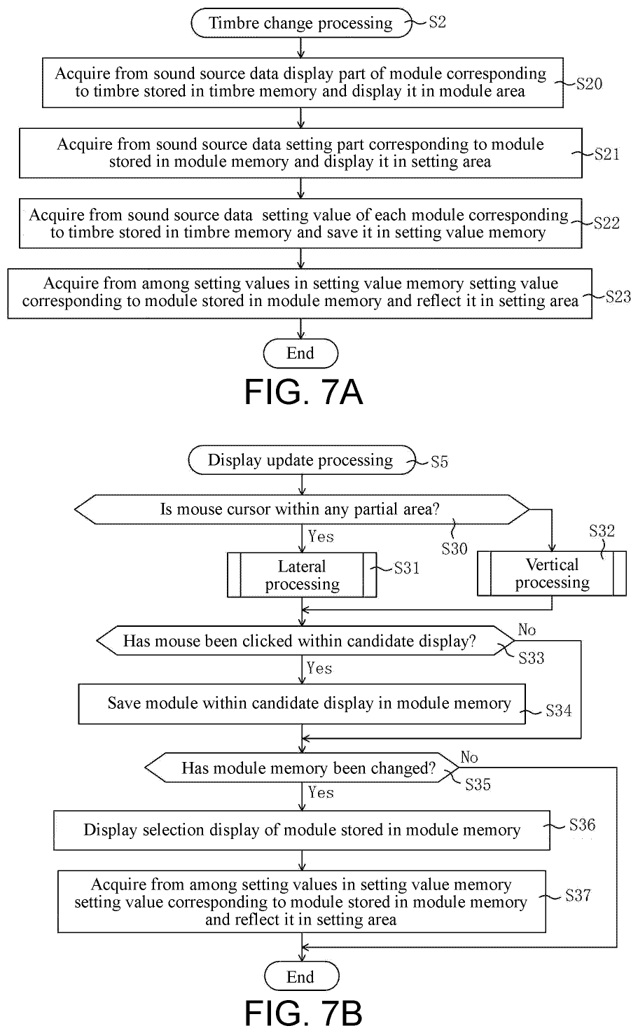

In the main processing, first, grand piano is saved as an initial value in the timbre memory 22a, and the pitch envelope, the oscillator, the first low frequency, and the second low frequency of the first partial are saved as initial values in the module memory 22b (S1). After S1, timbre change processing of S2 is executed. Here, the timbre change processing is described with reference to FIG. 7A.

FIG. 7A is a flowchart of the timbre change processing. In the timbre change processing, first, a display part of a partial and a module corresponding to the timbre stored in the timbre memory 22a is acquired from the sound source data 21b and displayed in the module area 10 (S20). After the processing of S20, a setting part corresponding to a module stored in the module memory 22b is acquired from the sound source data 21b and displayed in the setting areas Pe1 to Pe4, respectively (S21). After the processing of S21, a setting value of each module corresponding to the timbre stored in the timbre memory 22a is acquired from the sound source data 21b and saved in the setting value memory 22c (S22).

After the processing of S22, a setting value among the setting values of the modules stored in the setting value memory 22c that corresponds to the module stored in the module memory 22b is reflected in the corresponding setting areas Pe1 to Pe4 (S23), and the timbre change processing is ended. By such timbre change processing, the module area 10 and the setting areas Pe1 to Pe4 corresponding to the timbre or the module as the initial value or after change are displayed on the timbre setting screen 5a.

Please refer back to FIG. 6. After the timbre change processing of S2, it is confirmed whether the timbre has been changed by selecting the up button 7 or the down button 8 with the mouse 2 (S3). In the processing of S3, if it is confirmed that the timbre has been changed (S3: Yes), the timbre after change is saved in the timbre memory 22a (S4), and the timbre change processing of S2 described above is executed.

In the processing of S3, if it is not confirmed that the timbre has been changed (S3: No), the processing of S4 and S2 is skipped. After the processing of S3 and S2, display update processing of S5 is executed. Here, the display update processing is described with reference to FIG. 7B.

FIG. 7B is a flowchart of the display update processing. In the display update processing, first, it is confirmed whether the position of the mouse cursor Mc is within the region of the first partial area 11, the second partial area 12 or the third partial area 13 (S30).

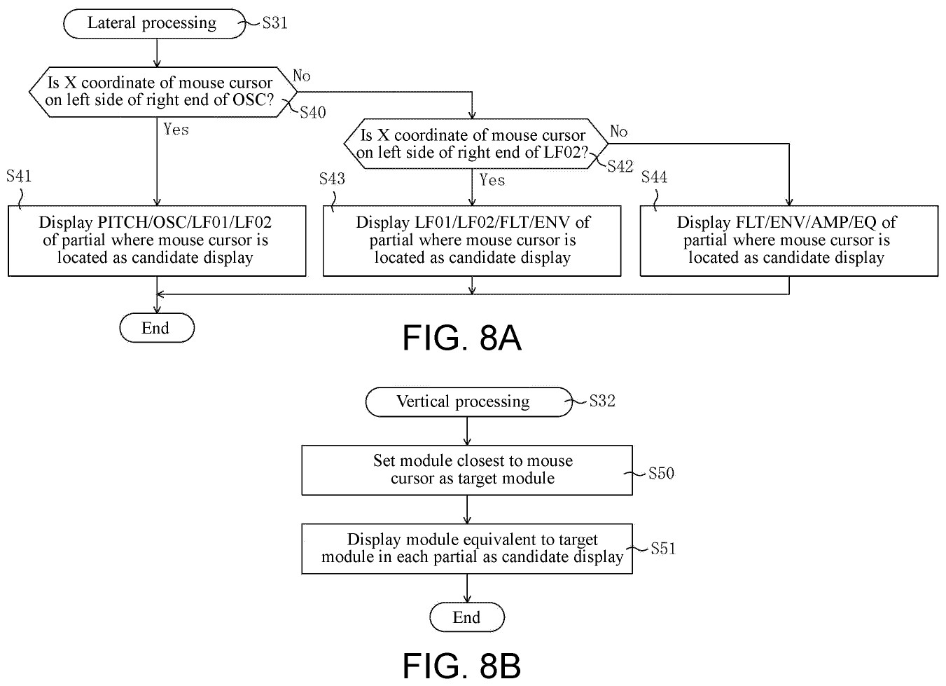

In the processing of S30, if the position of the mouse cursor Mc is within the region of the first partial area 11, the second partial area 12 or the third partial area 13 (S30: Yes), lateral processing of S31 is executed; if outside the region (S30: No), vertical processing of S32 is executed. Here, the lateral processing of S31 and the vertical processing of S32 are described with reference to FIG. 8A and FIG. 8B.

FIG. 8A is a flowchart of the lateral processing. In the lateral processing, first, it is confirmed whether an X coordinate of the mouse cursor Mc is on the left side of the right end of the oscillators 11b, 12b, and 13b (S40). In the processing of S40, if the X coordinate of the mouse cursor Mc is on the left side of the right end of the oscillators 11b, 12b, and 13b (S40: Yes), the pitch envelopes 11a, 12a, 13a, the oscillators 11b, 12b, 13b, the first low frequencies 11c, 12c, 13c and the second low frequencies 11d, 12d, 13d of the first partial area 11, the second partial area 12, or the third partial area 13 where the mouse cursor Mc is located are selected (surrounded) by the candidate display Sc (S41).

On the other hand, in the processing of S40, if the X coordinate of the mouse cursor Mc is on the right side of the right end of the oscillators 11b, 12b, and 13b (S40: No), it is confirmed whether the X coordinate of the mouse cursor Mc is on the left side of the right end of the second low frequencies 11d, 12d, and 13d (S42). In the processing of S42, if the X coordinate of the mouse cursor Mc is on the left side of the right end of the second low frequencies 11d, 12d, and 13d (S42: Yes), the first low frequencies 11c, 12c, 13c, the second low frequencies 11d, 12d, 13d, the filters 11e, 12e, 13e and the filter envelopes 11f, 12f, 13f of the first partial area 11, the second partial area 12, or the third partial area 13 where the mouse cursor Mc is located are selected by the candidate display Sc (S43).

On the other hand, in the processing of S42, if the X coordinate of the mouse cursor Mc is on the right side of the right end of the second low frequencies 11d, 12d, and 13d (S42: No), the filters 11e, 12e, 13e, the filter envelopes 11f, 12f, 13f, the amplifier envelopes 11g, 12g, 13g, and the equalizers 11h, 12h, 13h of the first partial area 11, the second partial area 12, or the third partial area 13 where the mouse cursor Mc is located are selected by the candidate display Sc (S44). After the processing of S41, S43, and S44, the lateral processing is ended. By such lateral processing, the candidate display Sc of the modules within the same partial described above is displayed in FIG. 3B.

Next, the vertical processing is described. FIG. 8B is a flowchart of the vertical processing. In the vertical processing, first, the module closest to the mouse cursor Mc is set as a target module (S50). A module in each partial that is equivalent to the target module is selected by the candidate display Sc (S51).

That is, since the position of the mouse cursor Mc is determined to be outside the partial areas 11, 12, and 13 by the processing of S30 in FIG. 7B, the module closest to the position of the mouse cursor Mc is acquired as the target module (S50), and the module in each partial that is equivalent to the target module is selected by the candidate display Sc (S51). By such vertical processing, the candidate display Sc of the modules across partials described above is displayed in FIG. 3C.

After the processing of S51, the vertical processing is ended.

Please refer back to FIG. 7B. After the processing of S31 and S32, it is confirmed whether the mouse 2 has been clicked within the candidate display Sc (S33). In the processing of S33, if the mouse 2 has been clicked (S33: Yes), the module selected in the candidate display Sc is saved in the module memory 22b (S34). On the other hand, in the processing of S33, if the mouse 2 has not been clicked (S33: No), the processing of S34 is skipped.

After the processing of S33 and S34, it is confirmed whether the module memory 22b has been changed by the processing of S34 or the like (S35). In the processing of S35, if it is confirmed that the module memory 22b has been changed (S35: Yes), a module in the module area 10 corresponding to the module stored in the module memory 22b is selected (surrounded) by the selection display Se (S36). At this time, the displayed candidate display Sc is removed.

After the processing of S35, a setting value among the setting values of the modules stored in the setting value memory 22c that corresponds to the module stored in the module memory 22b is reflected in the corresponding setting areas Pe1 to Pe4 (S37). According to the processing of S33 to S37, by clicking the mouse 2, the candidate display Sc is changed to the selection display Se, and the setting value of the module selected by the selection display Se is reflected in the corresponding setting areas Pe1 to Pe4.

In the processing of S35, if it is not confirmed that the module memory 22b has been changed (S35: No), the processing of S36 and S37 is skipped. After the processing of S35 and S37, the display update processing is ended.

Please refer back to FIG. 6. After the display update processing of S5, it is confirmed whether the setting has been changed in the setting areas Pe1 to Pe4 (S6). In the processing of S6, if it is confirmed that the setting has been changed in the setting areas Pe1 to Pe4 (S6: Yes), a setting value of the changed setting is saved in the setting value memory 22c (S7). On the other hand, in the processing of S6, if it is not confirmed that the setting has been changed in the setting areas Pe1 to Pe4 (S6: No), the processing of S7 is skipped.

After the processing of S6 and S7, it is confirmed whether the save button 9 has been selected by the mouse 2 (S8). In the processing of S8, if it is confirmed that the save button 9 has been selected (S8: Yes), the setting value stored in the setting value memory 22c is saved in the sound source data 21b (S9). Specifically, a setting value of the timbre in the sound source data 21b that corresponds to the timbre stored in the timbre memory 22a is overwritten by the setting value stored in the setting value memory 22c. In the processing of S8, if it is not confirmed that the save button 9 has been selected (S8: No), the processing of S9 is skipped. After the processing of S8 and S9, the processing of S3 onward is repeated.

Although the disclosure has been described above based on the above embodiment, it can be easily inferred that various improvements or modifications may be made.

In the above embodiment, all the timbres stored in the PC 1 are composed of three partials. However, the disclosure is not limited thereto. A timbre may be composed of three or more partials, or may be composed of three or fewer partials. For example, while grand piano includes three partials, drum may include four partials.

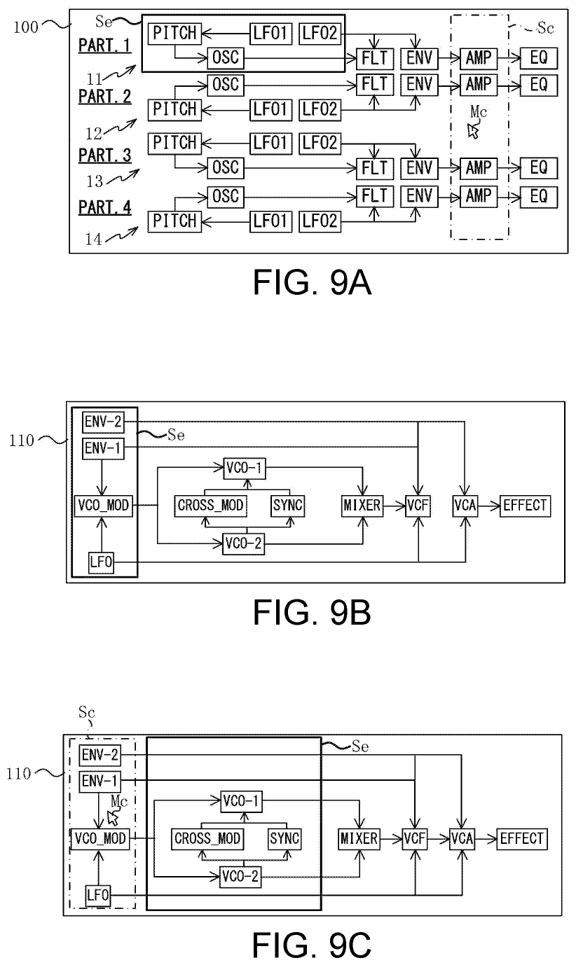

If a timbre is composed of four partials, like a module area 100 illustrated in FIG. 9A, a fourth partial area 14 may be displayed in addition to the first partial area 11 to the third partial area 13. On the other hand, the first partial area 11 to the third partial area 13 may be displayed in a module area as in FIG. 2A, and the user H may be able to specify which of the four partials is displayed in the first partial area 11 to the third partial area 13.

As illustrated in a module area 110 in FIG. 9B and FIG. 9C, a timbre may be composed of one partial. In other words, a timbre may be configured to have no partial. In this case, in the module area 110, as in the above embodiment, the selection display Se may be performed according to the position clicked with the mouse 2, and the candidate display Sc may be performed according to the position of the mouse cursor Mc. At this time, instead of the lateral processing and the vertical processing described above in FIG. 8A and FIG. 8B, lateral processing and vertical processing may be performed according to the arrangement of modules in the module area 110.

Furthermore, in the above embodiment, all of the first partial to the third partial are composed of the same modules. However, the disclosure is not limited thereto. The module configuration may be different for each partial. For example, while the first partial is composed of pitch envelope, oscillator, first low frequency, second low frequency, filter, filter envelope, amplifier envelope and equalizer, the second partial may omit filter and filter envelope and be composed of pitch envelope, oscillator, amplifier envelope, and equalizer.

Modules other than pitch envelope, oscillator, first low frequency, second low frequency, filter, filter envelope, amplifier envelope and equalizer may also be added to a partial.

In these cases, instead of the lateral processing and the vertical processing described above in FIG. 8A and FIG. 8B, lateral processing and vertical processing may be performed according to the modules arranged in each partial.

In the above embodiment, the modules displayed in the partial areas 11 to 13 are arranged according to the input-output relationship between the modules, that is, according to the degree of correlation between the modules. However, the disclosure is not limited thereto. The modules may be arbitrarily arranged without depending on the correlation between the modules. In this case, for example, each module may be arranged at a position specified by the user H via the mouse 2 in the partial areas 11 to 13.

In the above embodiment, the selection display Se and the candidate display Sc are regions surrounded by rectangular lines. However, the display form of the selection display Se and the candidate display Sc is not limited thereto. For example, the selection display Se or the candidate display Sc may be of other shapes such as a circle, an ellipse, a polygon, or an irregular shape. Furthermore, the selection display Se and the candidate display Sc may be of different shapes, such as the selection display Se being of a rectangular shape and the candidate display Sc being of an elliptical shape. This allows the user H to reliably distinguish between the selection display Se and the candidate display Sc.

The selection display Se and the candidate display Sc do not necessarily surround the corresponding regions with lines. For example, the lines of the selection display Se and the candidate display Sc may be omitted, and the corresponding regions may be filled in with a predetermined color. In this case, a transmittance of the color for filling is preferably set to, for example, 50%, so as to allow the user H to visually recognize both the selection display Se and the candidate display Sc in the filled-in form and a target module selected by the selection display Se and the candidate display Sc. Furthermore, the color for filling may be different between the selection display Se and the candidate display Sc, such as yellow for the selection display Se and blue for the candidate display Sc. This also allows the user H to reliably distinguish between the selection display Se and the candidate display Sc.

In the above embodiment, a module selected by the selection display Se and the candidate display Sc is set in advance according to the degree of correlation between the modules. However, the disclosure is not limited thereto. For example, a module selected in the selection display Se or the candidate display Sc may be arbitrarily set regardless of the importance of the module and the degree of correlation between the modules. For example, in FIG. 1B, the pitch envelope 11a and the oscillator 11b of the first partial area 11, and the oscillator 12b of the second partial area 12 may be the modules selected by the selection display Se or the candidate display Sc.

A plurality of selection displays Se or candidate displays Sc can be formed within the module area 10, and the modules selected by the plurality of selection displays Se may be displayed in the setting areas Pe1 to Pe4, respectively. Alternatively, the region of the selection display Se may be freely set using the mouse 2. At this time, the number of modules that can be selected by the selection display Se may be four or more or four or less. If four or more modules are selected by the selection display Se, the user H may further be able to specify the module to be set in the setting areas Pe1 to Pe4 among the selected four or more modules. By dragging a display part of any module within the module area 10 to any of the setting areas Pe1 to Pe4 using the mouse 2, it may be possible to specify the module to be set in the setting areas Pe1 to Pe4.

In this way, by making arbitrary the module selected by the selection display Se or the candidate display Sc, the modules that can be set at the same time in the setting areas Pe1 to Pe4 can be freely combined. Thus, the modules that are lowly correlated, for which the user H desires to perform setting, can be set at the same time in the setting areas Pe1 to Pe4.

In the above embodiment, in the partial areas 11 to 13, the modules arranged in the upper section and the modules arranged in the lower section are arranged so as not to overlap in the left-right direction. However, the disclosure is not limited thereto, and the modules may be arranged to overlap in the left-right direction.

For example, in FIG. 1B, the oscillator 11b may be arranged directly below the pitch envelope 11a in the first partial area 11, and the oscillator 12b may be arranged directly above the pitch envelope 12a in the second partial area 12. Accordingly, the pitch envelope 11a, the oscillator 11b, the pitch envelope 12a, and the oscillator 11b are aligned in the vertical direction. Furthermore, by selecting these modules in the vertical direction by the selection display Se, the settings of two types of modules across partials, namely, the pitch envelope 11a and the oscillator 11b, and the pitch envelope 12a and the oscillator 12b, are displayed in the setting areas Pe1 to Pe4. Thus, these modules can be efficiently set.

In the above embodiment, four setting areas Pe1 to Pe4 are provided as setting areas that set the module. However, the disclosure is not limited thereto, and the number of setting areas may be four or less or four or more. At this time, if the number of setting areas is less than the number of modules selected by the selection display Se, the user H may be able to specify the module to be set in the setting area among the modules selected by the selection display Se.

In the above embodiment, the timbre setting screen 5a for setting the timbre is displayed on the display device 5. However, on the timbre setting screen 5a or on another screen (including a screen displayed overlapping the timbre setting screen 5a) displayed at the same time as the timbre setting screen 5a or the like, a display part for performance such as a virtual keyboard simulating a keyboard may also be displayed. By operating the display part for performance, trial listening of the timbre being set or has already been set is possible.

In the above embodiment, the PC 1 is illustrated as an example of the computer that executes the timbre setting program 21a. However, the disclosure is not limited thereto. The timbre setting program 21a may be executed by an information processing device such as a smartphone or a tablet terminal, or an electronic musical instrument. In this case, instead of the mouse 2 and the keyboard 3, a touch panel may be provided over the display device 5. In this case, by tapping the module area 10 displayed on the display device 5 and on the touch panel, the candidate display Sc corresponding to the tapped position may be displayed, the candidate display Sc may be removed by tapping again, and the selection display Se may be displayed.

Alternatively, the timbre setting program 21a may be executed by an electronic musical instrument such as a synthesizer. In this case, a timbre may be set using the timbre setting program 21a executed on the electronic musical instrument, and the set timbre may be used in a performance by the electronic musical instrument. For example, by setting the timbre using the timbre setting program 21a during a performance by the electronic musical instrument, the timbre that matches the performance can be prepared in real time. Thus, an expressive musical tone can be output from the electronic musical instrument.

The disclosure may be applied to a dedicated device (timbre setting device) that stores the timbre setting program 21a in a ROM or the like and executes only the timbre setting program 21a.

What is claimed is:

1. A non-transitory computer-readable medium recording a timbre setting program that causes a computer equipped with a displayer and an input unit that accepts a user operation to execute timbre setting processing for setting a timbre, wherein the timbre setting program causes the computer to execute processing comprising:
displaying modules constituting the timbre on the displayer;
acquiring, in the modules displayed, a module selected via the input unit as a setting target module; and
displaying a setting area where the module acquired is set on the displayer.

2. The non-transitory computer-readable medium according to claim 1, wherein,
in displaying the modules, a module is arranged and displayed according to a correlation between the module and other modules; and
in acquiring the module, a plurality of highly correlated modules selected via the input unit are acquired together.

3. The non-transitory computer-readable medium according to claim 2, wherein
the timbre is configured by combining a plurality of partials each comprising a plurality of the modules;
in displaying the modules, a module is arranged and displayed for each partial; and
in acquiring the module, equivalent modules comprised in each of different partials selected via the input unit are acquired together.

4. The non-transitory computer-readable medium according to claim 3, wherein,
in displaying the modules, the partials are arranged and displayed side by side in an up-down direction.

5. The non-transitory computer-readable medium according to claim 2, wherein,
in acquiring the module, in a case that a position between modules is specified via the input unit, modules arranged in the vicinity of the specified position are acquired together.

6. The non-transitory computer-readable medium according to claim 1, wherein the timbre setting program causes the computer to further execute processing comprising:
performing a selection display indicating that the module acquired in the modules displayed is selected as the setting target module.

7. The non-transitory computer-readable medium according to claim 6, wherein the selection display is a display in which the module acquired in the modules displayed is surrounded by a region of a predetermined shape.

8. The non-transitory computer-readable medium according to claim 6, wherein the timbre setting program causes the computer to further execute processing comprising:
in a case that a position is specified via the input unit, acquiring a module arranged in the vicinity of the specified position; and
performing a candidate display indicating that, in the modules displayed, the module acquired that is arranged in the vicinity of the specified position is a candidate for the setting target module, and
in acquiring the module, in a case that an instruction to confirm the candidate display is given via the input unit, the module acquired that is arranged in the vicinity of the specified position is acquired as the setting target module.

9. A timbre setting device, comprising:
an input part, accepting a user operation;
a module display part, displaying modules constituting a timbre;
an acquisition part, acquiring, in the modules displayed by the module display part, a module selected via the input part as a setting target module; and
a setting area display part, displaying a setting area where the module acquired by the acquisition part is set.

10. The timbre setting device according to claim 9, wherein
the module display part arranges and displays a module according to a correlation between the module and other modules; and
the acquisition part acquires a plurality of highly correlated modules selected via the input part together.

11. The timbre setting device according to claim 10, wherein
the timbre is configured by combining a plurality of partials each comprising a plurality of the modules;
the module display part arranges and displays a module for each partial; and
the acquisition part acquires equivalent modules comprised in each of different partials selected via the input part together.

12. The timbre setting device according to claim 11, wherein
the module display part arranges and displays the partials side by side in an up-down direction.

13. The timbre setting device according to claim 10, wherein
in a case that a position between modules is specified via the input part, the acquisition part acquires modules arranged in the vicinity of the specified position together.

14. The timbre setting device according to claim 9, further comprising:
a selection display, indicating that the module acquired by the acquisition part in the modules displayed by the module display part is selected as the setting target module.

15. The timbre setting device according to claim 14, wherein
the selection display is a display in which the module acquired by the acquisition part in the modules displayed by the module display part is surrounded by a region of a predetermined shape.

16. The timbre setting device according to claim 14, wherein
in a case that a position is specified via the input part, a module arranged in the vicinity of the specified position is acquired; and
the timbre setting device further comprises a candidate display indicating that, in the modules displayed by the module display part, the module acquired that is arranged in the vicinity of the specified position is a candidate for the setting target module, and
in a case that an instruction to confirm the candidate display is given via the input part, the acquisition part acquires the module acquired that is arranged in the vicinity of the specified position as the setting target module.

17. A timbre setting method, executed by a timbre setting device equipped with an input part that accepts a user operation, the timbre setting method comprising:
displaying modules constituting a timbre;
acquiring, in the modules displayed, a module selected via the input part as a setting target module; and
displaying a setting area where the module acquired is set.

18. The timbre setting method according to claim 17, wherein,
in displaying the modules, a module is arranged and displayed according to a correlation between the module and other modules; and
in acquiring the module, a plurality of highly correlated modules selected via the input part are acquired together.

19. The timbre setting method according to claim 18, wherein
the timbre is configured by combining a plurality of partials each comprising a plurality of the modules;
in displaying the modules, a module is arranged and displayed for each partial; and
in acquiring the module, equivalent modules comprised in each of different partials selected via the input part are acquired together.

20. The timbre setting method according to claim 19, wherein,
in displaying the modules, the partials are arranged and displayed side by side in an up-down direction.
